(19) United States
(12) Patent Application Publication
(10) Pub. No.: US 2025/0065262 A1
(43) Pub. Date: Feb. 27, 2025

(54) METHOD FOR TREATING SMOKE CONTAINING CARBON DIOXIDE

(71) Applicant: L'Air Liquide, Societe Anonyme pour l'Etude et l’Exploitation des Procedes Georges Claude, Paris (FR)

(72) Inventors: Marine ANDRICH, Champigny sur Marne (FR); Jean-Marc PEYRON, Champigny sur Marne (FR); Bhadri PRASAD, Champigny sur Marne (FR); Ludovic GRANADOS, Champigny sur Marne (FR); Olivier de CAYEUX, Champigny sur Marne (FR)

(73) Assignee: L'Air Liquide, Societe Anonyme pour l'Etude et l’Exploitation des Procedes Georges Claude, Paris (FR)

(21) Appl. No.: 18/723,392

(22) PCT Filed: Dec. 15, 2022
(86) PCT No.: PCT/EP2022/086022

§ 371 Date: Jun. 21, 2024

(30) Foreign Application Priority Data
Dec. 21, 2021 (FR) FR 2114055

(51) Int. Cl. B01D 53/30; B01D 53/00; B01D 53/047; B01D 53/14; B01D 53/62; B01D 53/78; C01B 3/38; C01B 3/50; C01B 3/52; C01B 3/56

(52) U.S. Cl. CPC B01D 53/30; B01D 53/002; B01D 53/047; B01D 53/1437; B01D 53/1475; B01D 53/62; B01D 53/78; C01B 3/38; C01B 3/506; C01B 3/52; C01B 3/56; B01D 2257/504; B01D 2258/0283; C01B 2203/0233; C01B 2203/0415; C01B 2203/043; C01B 2203/046; C01B 2203/0475

(57) ABSTRACT

A process for treating a flue gas produced in at least one upstream unit operating at a nominal operating pressure, the flue gas containing from 5 mol % to 90 mol % of CO2 on a wet basis and being at a pressure between 0.5 and 2 bar absolute. The process includes treating, via at least one downstream treatment unit, all or virtually all of the stream of flue gas originating from the upstream unit or upstream units, thereby producing, from the flue gas, a gaseous or liquid stream rich in CO2 which contains more than 50 mol % of CO2. Then enabling the stream of flue gas to communicate, between the upstream unit and the downstream unit with a stack opening to the atmosphere, and this outlet line is left open or partially open in nominal operation thereby equilibrating the pressure in the stream of flue gas to atmospheric pressure.

### CROSS-REFERENCE TO RELATED APPLICATIONS

This application is a § 371 of International PCT Application PCT/EP2022/086022, filed Dec. 15, 2022, which claims § 119(a) foreign priority to French patent application FR 2114055, filed Dec. 21, 2021.

### BACKGROUND

The present invention relates to a process for treating flue gas containing carbon dioxide.

### FIELD OF THE INVENTION

Hydrogen is an energy carrier that plays an increasing role in the decarbonization of various sectors, in particular transport and industry. Hydrogen can be produced from the reforming reaction of natural gas (in SMR [Steam Methane Reforming] furnaces) or by electrolysis of water. Electrolysis of water has the advantage of not producing greenhouse gases but consumes a lot of electricity (decarbonized if possible). In SMRs, hydrogen production is accompanied by significant CO₂ production. A CO₂ capture unit can be added to an SMR in order to reduce the carbon footprint of the production of hydrogen by SMR. CO₂ capture (e.g. CO₂ treatment and liquefaction for food use or for sequestration) can be carried out cryogenically or non-cryogenically (for example, amine scrubbing).

### RELATED ART

The flue gases are extracted from the SMR furnace via a pipe and then pass through a certain number of exchangers, the purpose of which is to recover a portion of the heat from the flue gases, then the flue gases are sucked up by a blower and sent via a stack to the outside air. In this case, there is no CO₂ capture.

When a CO₂ treatment or capture unit is connected to the outlet of an SMR, it is important to guarantee that disturbances on the downstream unit do not generate failure mode of the SMR upstream. Furthermore, in the case where several SMRs are connected to the same downstream treatment unit, a disturbance or the failure mode of an SMR must not generate the failure mode of the other SMRs. On an SMR without CO₂ capture, the pressure downstream of the blower is imposed by the atmospheric pressure due to the fact that the blower is fluidically connected to the outside air via the stack. This pressure is therefore stable and enables fine control, by the blower, of the pressure in the SMR furnace.

There is a need to treat virtually all of the flue gas leaving for example an SMR, in particular to reduce the carbon footprint of the industrial units producing a flue gas containing CO₂.

### SUMMARY OF THE INVENTION

One subject of the invention is thus a process for treating a flue gas produced in at least one upstream unit operating at a nominal operating pressure, this flue gas containing from 5 mol % to 90 mol % of carbon dioxide (CO₂) on a wet basis and being at a pressure between 0.5 and 2 bar absolute, preferentially between 0.9 and 1.1 bar absolute, this process comprising the following steps:
treating, via at least one downstream treatment unit, all or virtually all of the stream of flue gas originating from the upstream unit or upstream units, in order to produce, from said flue gas, a gaseous or liquid stream rich in CO₂ which contains more than 50 mol %, preferably more than 75%, or even more than 95 mol % of CO₂,
enabling the stream of flue gas to communicate, between the upstream unit and the downstream unit, via an outlet line, with a stack opening to the atmosphere, and this outlet line is left open or partially open in nominal operation so as to make it possible to equilibrate the pressure in the stream of flue gas to atmospheric pressure.

In the present invention, treating all or virtually all of the stream of flue gas means treating at least 90%, preferably at least 95%, or even at least 97% of the flue gases.

It should be understood that “this outlet line is left open or partially open” means either the situation in which a valve device, present on the outlet line, is left open or partially open, or the situation in which no valve device is provided on the outlet line, which means that the outlet line is permanently open.

According to one of the aspects of the invention, the process comprises the following steps:
detecting at least one item of information for predicting the variation of a flow rate of flue gas leaving the upstream unit, this predictive information item being different from a measurement of pressure, flow rate or overall composition of the flue gases,
regulating the flow rate of flue gas between the upstream unit and the downstream treatment unit as a function of this predictive information item using a valve device for the passage of the flue gas and/or a pressure increase device positioned between the upstream unit and the downstream unit or within the downstream unit.

The predictive information item may be for example the measurement of a concentration of O₂ in the flue gas, this measurement not being a measurement of overall composition. The predictive information item may be a flow rate of the various gases entering the upstream unit which represent at least 80% of all of the gases entering the upstream unit.

These flue gases may originate from an SMR reformer, a cement works, an oxycombustion unit, or a lime factory for example. In the invention, the valve device generally denotes a device of variable flow area, in particular for the flue gas.

According to one of the aspects of the invention, a valve device is positioned:
on the outlet line which communicates between the stack and a line for flow of flue gas between the upstream unit and the downstream unit, or
on a line for flow of flue gas between the upstream unit and the downstream unit, or
in the stack,
this valve device being arranged in order to be open or partially open and the valve device comprises a valve which is for example a butterfly valve such as a damper butterfly valve.

In one variant, it is possible to not provide any valve, in particular in the case where the line for flow between the upstream unit and the downstream unit may be completely in communication with the atmosphere.

According to one of the aspects of the invention, the valve device is arranged to have an opening between 5% and 100% of the maximum opening permitted by the valve device.

This makes it possible to take into account a small disturbance of the upstream unit by having the time to adjust the regulation of the flow rates, for the purpose of minimizing the inlets of O₂ or outlet of flue gases by restricting the line, owing to the valve device, while being connected to the atmosphere in order to maintain a stable pressure. The invention thus makes it possible to smooth out the disturbances since the downstream unit may be a powerful machine that naturally has inertia in order to deal with rapid variations.

According to one of the aspects of the invention, a pressure increase device, in particular placed in the downstream unit, capable of increasing the pressure of the gaseous stream of flue gas, is provided, the pressure increase device comprising in particular a compressor or a blower.

According to one of the aspects of the invention, the compressor or the blower is of variable vane type, making it possible to modify the inclination of the blades of the compressor or of the blower in order to adjust the flow rate or pressure.

According to one of the aspects of the invention, the rotational speed of this compressor or of this blower can be controlled by a control unit in particular in order to be increased, respectively decreased, in order to regulate the flow rate of flue gas in the direction of an increase, respectively of a decrease.

The variable vane may comprise a plurality of guide blades configured to deflect the flow of the gas phase in the flow line and these guide blades are adjustable in inclination relative to an axis in order to determine the pressure of the fluid which crosses this variable vane.

According to one of the aspects of the invention, the process comprises the following steps:
measuring at least one flow rate of gas entering the upstream unit, in particular the flow rate of the various gases entering the upstream unit which represent at least 80% of all of the gases entering the upstream unit, these measured flow rates forming part of an item of information for predicting the variation of a flow rate of flue gas leaving the upstream unit,
regulating the flow rate of flue gas between the upstream unit and the downstream unit as a function of the predictive information item which is this or these measured flow rate(s), in particular by increasing the flow rate of flue gas leaving the upstream unit by sucking up more flue gas, in particular by increasing the flow area of a valve device and/or by increasing the rotational speed of the compressor or of the blower and/or by modifying the position of a variable vane of the compressor or of the blower.

According to one of the aspects of the invention, the process comprises the following steps:
measuring one or more oxygen concentrations in the flow of flue gas, or a difference in oxygen concentration between the inlet of the downstream unit and the outlet of the upstream unit, and/or
measuring one or more temperatures of the air in the stack or originating from the stack,
determining, from these measurements, if air originating from the atmosphere is adding to the flow of flue gas, or if flue gas is escaping into the atmosphere through the stack,
regulating the flow rate of flue gas to prevent this addition of air to the flow of flue gas or to prevent flue gas from escaping into the atmosphere.

In order to reduce the amount of air entering the downstream unit, the regulation consists in particular in decreasing the flow area of a valve device and/or in reducing the rotational speed of the compressor or of the blower and/or in modifying the position of the variable vane of the compressor or of the blower. In order to reduce the amount of flue gas that escapes into the atmosphere, the regulation consists in particular in increasing the flow area of a valve device and/or in increasing the rotational speed of the compressor or of the blower and/or in modifying the position of the variable vane.

According to one of the aspects of the invention, a failure mode or a disturbance or an alarm of the upstream device is taken into account in order to regulate the flow rate of flue gas arriving in the downstream treatment unit, an item of information for predicting the variation of a flow rate of flue gas leaving the upstream unit then being the detection of this failure mode or this disturbance or this alarm.

According to one of the aspects of the invention, the upstream treatment unit comprises a pressure swing adsorption (PSA) device, and a failure mode or a disturbance or an alarm of this PSA device is taken into account in order to regulate the flow rate of flue gas arriving in the downstream treatment unit, an item of information for predicting the variation of a flow rate of flue gas leaving the upstream unit then being the detection of this failure mode or this disturbance or this alarm.

According to one of the aspects of the invention, the upstream unit or at least one of the upstream units is a steam methane reforming unit (SMR).

According to one of the aspects of the invention, the downstream unit comprises one or more units for purifying CO₂ cryogenically, or one or more amine scrubbing units.

According to one of the aspects of the invention, the upstream units and downstream units are connected to a same flue gas network.

According to one of the aspects of the invention, the process comprises the following steps:
treating, via a downstream treatment unit, all or virtually all of the stream of flue gas originating from the upstream unit or upstream units, in order to produce, from said flue gas, a gaseous or liquid stream rich in CO₂ which contains more than 50 mol %, preferably more than 75%, or even more than 95 mol % of CO₂,
detecting an item of information for predicting the variation of a flow rate of flue gas leaving the upstream unit,
regulating the flow rate of flue gas between the upstream unit and the downstream treatment unit as a function of this predictive information item.

The invention makes it possible, owing to this flue gas flow rate regulation, to act on the operating pressure of the upstream unit and/or to act on the proportion of flue gas which is treated by the downstream treatment unit, as is explained below.

As virtually all of the flue gas leaving the upstream unit is treated in the downstream unit, the flue gas flow has an impact on the operation of the upstream unit, in particular with a risk of having failure modes of the upstream unit. The invention thus makes it possible to prevent this type of triggering of failure mode, which may lead to an undesired shutdown of the upstream unit. The invention thus proposes to use anticipation, made possible owing to the item of information for predicting the variation of a flow rate of flue gas leaving the upstream unit.

According to one of the aspects of the invention, the process comprises the following steps:
measuring at least one flow rate of gas entering the upstream unit, in particular the flow rate of the various gases entering the upstream unit which represent at least 80% of all of the gases entering the upstream unit, these measured flow rates forming part of the predictive information item,
regulating the flow rate of flue gas between the upstream unit and the downstream unit as a function of this or these measured flow rate(s), in particular by increasing the flow rate of flue gas leaving the upstream unit by sucking up the flue gas more.

According to one of the aspects of the invention, a pressure increase device capable of increasing the pressure of the gaseous stream of flue gas between the upstream unit and the downstream unit and/or a valve device positioned between the upstream unit and the downstream unit and having a variable flow area for the stream of flue gas, are provided, to regulate the flow rate of flue gas between the upstream unit and the downstream unit.

According to one of the aspects of the invention, the pressure increase device comprises a compressor or a blower and the rotational speed of this compressor or of this blower can be controlled by a control unit in particular in order to be increased, respectively decreased, in order to regulate the flow rate of flue gas in the direction of an increase, respectively of a decrease.

The fact of measuring the flow rates of gas, for example of air and of methane and optionally of exhaust gas from a PSA entering the upstream unit, makes it possible to anticipate the variations of flow rate of flue gas at the outlet of the upstream unit and/or pressure variations in this upstream unit. This anticipation makes it possible to better regulate the flow rate to be treated in the downstream unit and to prevent failure modes that may lead to the shutdown of the upstream unit and/or the downstream unit, in particular when virtually all of the flue gases are treated in the downstream unit.

This anticipation completes the control of the pressure at the outlet of the upstream unit and/or the control over the flow rate of the flue gases to the downstream unit, with a view to effective regulation, without waiting for example to detect a pressure increase which may prove problematic, owing to the reaction time of the system and its sensitivity to a pressure variation.

In a different approach, the flow of flue gas between the upstream unit and the downstream treatment unit is, in nominal operation, isolated from the atmosphere, in particular isolated from a stack into which flue gas originating from the upstream unit may be sent if need be.

In this example, a valve device is positioned on the outlet line which communicates between a stack and a line for flow of flue gas between the upstream unit and the downstream unit, this valve device being arranged to be closed to isolate the stack from the line for flow of flue gas between the upstream unit and the downstream unit.

According to one of the aspects of the invention, the valve device comprises a butterfly valve such as a damper butterfly valve.

According to one of the aspects of the invention, the process comprises the following step:
regulating the flow rate of flue gas to the downstream treatment unit with a view to maintaining the operating pressure at the outlet of the upstream unit at the nominal operating pressure, the nominal operating pressure being governed in particular by the atmospheric pressure.

Preferably, the nominal operating pressure corresponds to the atmospheric pressure.

According to one of the aspects of the invention, the process comprises the following steps:
measuring the pressure in the flow of gas between the upstream unit and the downstream unit, in particular the pressure at the outlet of the upstream unit, this pressure measurement being a predictive information item,
regulating the flue gas flow rate as a function of this pressure measurement, with a view to maintaining the operating pressure at the outlet of the upstream unit at its nominal value.

According to one of the aspects of the invention, the downstream unit comprises a compressor, in particular the drive of which is at least partially transmitted by an electric motor, and the rotational speed of this compressor can be controlled by a control unit, in particular in order to be increased, respectively decreased, in order to regulate the flow rate of flue gas entering the downstream unit in the direction of an increase, respectively of a decrease, in order to lower, respectively increase, the operating pressure in the upstream unit.

In the case where the flow of flue gas between the upstream unit and the downstream treatment unit is, in nominal operation, isolated from the atmosphere, the pressure in the upstream unit cannot be equalized with the atmospheric pressure. In this case, it is possible to ensure that the nominal operating pressure of the upstream unit is maintained, to within a tolerance interval, for example of a few millibars. Specifically, for safety reasons, when the operating pressure of the upstream unit departs from this tolerance interval, an alarm sequence may be started and the upstream unit may potentially undergo an emergency shutdown, which should, of course, be avoided.

When the upstream unit comprises a blower for discharging the flow of flue gas, the discharge pressure of the blower is not imposed by the atmospheric pressure (since it is isolated from the atmosphere), but by the intake pressure of the downstream unit. A disturbance or a failure mode, for example an emergency shutdown, of the downstream unit may then give rise to a failure mode of the upstream unit, which upstream unit has a high sensitivity in the sense that the differences tolerated with respect to the nominal operating pressure are very low. The control of the operating pressure of the upstream unit should thus be carried out in a reactive manner by means of the regulation of the flue gas flow rate.

The fact of isolating the flow of flue gas from the atmosphere, in particular from the stack, further makes it possible to eliminate or greatly limit intakes of air into the flue gases via the stack. This makes it possible to guarantee that all or virtually all of the flue gas is treated in the downstream treatment unit, and prevent outside air, which would be added to the flow of flue gas to be treated, from leading to a need for additional treatment capacity in the downstream unit owing to this undesirable excess air flow. Furthermore, flue gas is prevented from escaping into the atmosphere via the stack.

According to one of the aspects of the invention, the flow of flue gas between the upstream unit and the downstream treatment unit is, in nominal operation, in pressure equilibrium with the atmosphere.

According to one of the aspects of the invention, the flow of flue gas communicates, via an outlet line, with a stack opening to the atmosphere, and this outlet line is left open or partially open in nominal operation so as to make it possible to equilibrate the pressure in the flow of flue gas to atmospheric pressure.

According to one of the aspects of the invention, a valve device is positioned on the outlet line which communicates between the stack and a line for flow of flue gas between the upstream unit and the downstream unit, this valve device being arranged to be open or partially open.

The invention makes it possible, in this case, to ensure that the pressure in the upstream unit is maintained at the nominal operating pressure, here atmospheric pressure, except for head losses. Thus, the risk of failure mode of the upstream unit is avoided owing to the stability of the pressure.

According to one of the aspects of the invention, the process comprises the following step:
regulating the flow rate of flue gas between the upstream unit and the downstream unit so as to prevent an intake of air into the flow of flue gas or a portion of the flue gas from being introduced into the stack then escaping into the atmosphere.

The choice of the flow rate of flue gas thus ensures that all or virtually all of the flue gases, in particular at least 90%, preferably at least 95%, or even at least 97% of the flue gases, is treated by the downstream unit. Outside air is prevented from adding to the flow of flue gas to be treated and from leading to a need for additional treatment capacity in the downstream unit owing to this undesirable excess air flow. Furthermore, flue gas that contains CO₂ is prevented from escaping into the atmosphere via the stack.

According to one of the aspects of the invention, the process comprises the following steps:
measuring one or more oxygen concentrations in the flow of flue gas, or a difference in oxygen concentration between the inlet of the downstream unit and the outlet of the upstream unit, and/or
measuring one or more temperatures of the air in the stack or originating from the stack,
determining, from these measurements, if air originating from the atmosphere is adding to the flow of flue gas, or if flue gas is escaping into the atmosphere through the stack,
regulating the flow rate of flue gas to prevent this addition of air to the flow of flue gas or to prevent flue gas from escaping into the atmosphere.

In the case where the difference in oxygen concentration increases between the inlet of the treatment unit and the outlet of the upstream unit or in the case where the oxygen concentration measured at the inlet of the downstream unit increases, a control unit orders a reduction of the flow rate of flue gas between the upstream unit and the downstream unit.

In the case where the temperature of the gases in the stack increases, the control unit orders a reduction of the flow rate of flue gas between the upstream unit and the downstream unit.

It should be noted that the configuration with the stream of flue gas isolated from the atmosphere is an advantageous solution for treating 100% of the flue gases but which has the drawback of making the system (upstream unit+downstream unit) very sensitive to external disturbances or disturbances of the process itself, which could generate failure modes of the upstream unit. In contrast, the configuration with the stream of flue gas in pressure equilibrium with the atmosphere according to the invention makes it possible to have a system that is less sensitive to disturbances.

According to one of the aspects of the invention, the upstream treatment unit comprises a pressure swing adsorption (PSA) device.

A failure mode or a disturbance or an alarm of this PSA device is taken into account in order to regulate the flow rate of flue gas arriving in the downstream treatment unit or the flow rate of gases entering the upstream unit. For example, a shutdown or an alarm of the PSA unit may be anticipated in the control of the flow rate of the flue gases to be treated.

According to one of the aspects of the invention, several upstream units are connected to the downstream treatment unit. These upstream units may be identical or of identical technology or, as a variant, of different technologies.

According to one of the aspects of the invention, the upstream unit comprises a blower and a valve device capable of regulating the flow rate of flue gas leaving this upstream unit.

According to one of the aspects of the invention, the upstream unit is a unit for producing synthesis gas from a hydrocarbon feedstock.

According to one of the aspects of the invention, the upstream unit is chosen from: a steam methane reforming unit (SMR), a lime production unit, a cement production unit, a refinery, an oxycombustion unit.

According to one of the aspects of the invention, the upstream unit comprises a steam methane reformer (SMR).

It should be noted that the flue gases of a steam methane reformer (SMR) produce a gas containing around 10 mol % to 20 mol % of CO₂ and also approximately 50 mol % to 70 mol % of nitrogen on a wet basis.

According to one of the aspects of the invention, the upstream unit carries out at least one step of generating a crude synthesis gas by steam reforming with production of the heat needed for the reforming using a combustion in a reforming furnace comprising a combustion chamber and a convection chamber for discharging the flue gases, the combustion chamber containing vertical tubes filled with catalyst, capable of circulating a mixture of hydrocarbons and steam from top to bottom, and burners fed with fuel and oxidizer, and producing, via combustion, flames capable of supplying the tubes with the heat needed for the reforming, and optionally steps of using, in a convection chamber, heat contained in the flue gases for the preheating and/or heating of various fluids.

According to one of the aspects of the invention, the upstream unit is arranged in order to produce an H₂/CO synthesis gas by steam methane reforming (SMR) or steam reforming of other light hydrocarbons, at very high temperature.

According to one of the aspects of the invention, several reactions occur during this reforming step, and although some are exothermic, the initial and main reaction is itself endothermic, so that it is necessary to supply heat for this step of generating the synthesis gas.

Other types of upstream units may be provided.

The gas, or flue gas, to be treated in the downstream unit may be derived from a combustion, for example an oxycombustion, from fermentation, from a PSA for removal of hydrogen, from a steelworks, from a cement works, from the production of ammonia, lime or ethylene oxide. It may be natural gas or biomethane also containing methane in both cases.

According to one of the aspects of the invention, the downstream unit comprises a unit for purifying CO₂ cryogenically, or one or more amine scrubbing units.

According to one of the aspects of the invention, the flue gas, or gas rich in carbon dioxide, is firstly purified and/or cooled in a scrubbing tower, then is compressed in a compressor. The gas is then dried in a dryer which may be an adsorption unit. The dried gas may then be used as dry product or be purified by another means such as another adsorption unit and/or a membrane and/or a unit for separation at a temperature below 0° C., for example by partial condensation and/or distillation. It will be understood that the dryer does not necessarily operate via adsorption. The gas may simply be cooled and/or pressurized to condense the water that it contains. A unit for purifying CO₂ cryogenically is provided.

The downstream unit thus enables the capture of CO₂.

The downstream unit may be of any other type, for capturing CO₂ in a flue gas or gas.

According to one of the aspects of the invention, the upstream treatment unit comprises a pressure swing adsorption (PSA) device, and a failure mode or a disturbance or an alarm of this PSA device is taken into account in order to regulate the flow rate of flue gas arriving in the downstream treatment unit, the item of information for predicting the variation of a flow rate of flue gas leaving the upstream unit then being the detection of this failure mode or this disturbance or this alarm.

Another subject of the invention is a plant for treating a flue gas produced in at least one upstream unit operating at a nominal operating pressure, this flue gas containing from 5 mol % to 90 mol % of carbon dioxide (CO₂) on a wet basis and being at a pressure between 0.5 and 2 bar absolute, preferentially between 0.9 and 1.1 bar absolute, this plant comprising:
at least one downstream treatment unit in order to treat all or virtually all of the stream of flue gas originating from the upstream unit or upstream units, in order to produce, from said flue gas, a gaseous or liquid stream rich in CO₂ which contains more than 50 mol %, preferably more than 75%, or even more than 95 mol % of CO₂,
an outlet line enabling the stream of flue gas to communicate, between the upstream unit and the downstream unit, with a stack opening to the atmosphere, and this outlet line is left open or partially open in nominal operation so as to make it possible to equilibrate the pressure in the stream of flue gas to atmospheric pressure.

This plant makes it possible to implement the treatment process according to the invention as described above.

According to one of the aspects of the invention, the upstream unit is a unit for producing synthesis gas from a hydrocarbon feedstock.

According to one of the aspects of the invention, the downstream unit comprises a unit for purifying CO₂ cryogenically, the downstream unit comprises a unit for purifying CO₂ cryogenically, or one or more amine scrubbing units.

### BRIEF DESCRIPTION OF THE FIGURES

The invention will be understood better from reading the following description and from studying the accompanying figures. These figures are given only by way of illustration and do not in any way limit the invention.

FIG. 1 is a schematic and partial representation of an example of a treatment plant;

FIG. 2 is a schematic and partial representation of a treatment plant according to one exemplary embodiment of the invention;

FIG. 3 is a schematic and partial representation of a treatment plant according to another exemplary embodiment of the invention; and

FIG. 4 represents functional blocks of the downstream unit according to one example of the invention.

### DETAILED DESCRIPTION OF THE INVENTION

Those elements which are identical, similar or analogous keep the same reference from one figure to the next.

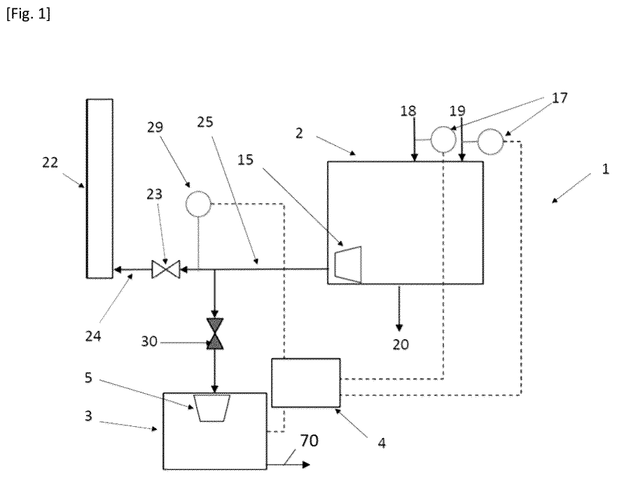

Represented in FIG. 1 is a plant 1 for treating a flue gas, comprising:
an upstream unit 2 operating at a nominal operating pressure, and producing the flue gas during its operation, this flue gas containing carbon dioxide (CO₂),
a downstream treatment unit 3 in order to treat all or virtually all of the flue gas, in particular at least 90% of the flue gas, originating from the upstream unit, in order to produce, from said flue gas, a gaseous or liquid stream rich in CO₂ which contains around 95 mol % of CO₂,
a control unit 4 arranged to detect an item of information for predicting the variation of a flow rate of flue gas leaving the upstream unit, and to regulate the flow rate of flue gas between the upstream unit 2 and the downstream treatment unit 4 as a function of this predictive information item.

In the example described, the upstream unit 2 is a unit for producing synthesis gas from a hydrocarbon feedstock, of SMR type.

The flue gas contains from 5 mol % to 90 mol % of carbon dioxide (CO₂) on a wet basis and being at a pressure between 0.5 and 2 bar absolute, preferentially between 0.9 and 1.1 bar absolute.

This upstream unit 2 is arranged in order to produce an H₂/CO synthesis gas by steam methane reforming (SMR) or steam reforming of other light hydrocarbons, at very high temperature.

Thus, the upstream unit 2 carries out a step of generating a crude synthesis gas by steam reforming with production of the heat needed for the reforming using a combustion in a reforming furnace comprising a combustion chamber and a convection chamber for discharging the flue gases, the combustion chamber containing vertical tubes filled with catalyst, capable of circulating a mixture of hydrocarbons and steam from top to bottom, and burners fed with fuel and oxidizer, and producing, via combustion, flames capable of supplying the tubes with the heat needed for the reforming, and optionally steps of using heat contained in the flue gases for the preheating and/or heating of various fluids.

The upstream unit 2 comprises a blower 15 and a valve device or vane device, not shown, capable of regulating the flow rate of flue gas leaving this upstream unit as a function of the pressure in the combustion chamber.

The downstream unit 3 comprises a unit 13 for purifying CO₂ cryogenically, or by amine scrubbing.

The downstream unit 3 comprises a CO₂ outlet line 70.

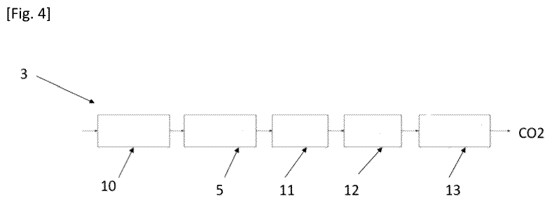

FIG. 4 illustrates, in blocks, the main functions of the downstream unit 3.

Thus the flue gas, or gas rich in carbon dioxide, is firstly purified and/or cooled in a scrubbing tower 10, then is compressed in a compressor 5. The gas is then dried in a dryer 11 which may be an adsorption unit. The dried gas may then be used as dry product or be purified by another means such as another adsorption unit 12 (for example of PSA type) and/or a membrane and/or a unit for separation at a temperature below 0° C., for example by partial condensation and/or distillation. It will be understood that the dryer does not necessarily operate via adsorption. The gas may simply be cooled and/or pressurized to condense the water that it contains. A unit 13 for purifying the CO₂ cryogenically is provided, which unit comprises a nitrogen circuit.

Within the context of amine scrubbing, the scrubbing tower and the compressor/blower are encountered again but not necessarily the dryer 11 and the adsorption unit 12 for pre-concentrating in CO₂.

The plant 1 enables the implementation of a process for treating a flue gas produced in the upstream unit 2 operating at a nominal operating pressure, this flue gas containing carbon dioxide (CO₂), this process comprising the following steps:
treating, via the downstream unit 3, around at least 90%, preferably at least 95%, or even at least 97%, of the flue gases originating from the upstream unit 2, in order to remove the CO₂ from the flue gas with a view to the capture thereof,
regulating the flow rate of flue gas between the upstream unit 2 and the downstream treatment unit 3.

The process comprises the following steps:
measuring flow rates of gas entering the upstream unit 2, here by means of flow rate sensors 17 on the incoming flows of air 18, of natural gas 19 and an exhaust gas from a PSA unit,
regulating, with the aid of the control unit 4, the flow rate of flue gas between the upstream unit 2 and the downstream unit 3 as a function of this or these measured flow rate(s), in particular by increasing this flow rate of flue gas.

In the example described, the measurements of flow rates of gas entering the upstream unit 2 by means of flow rate sensors 17 on the incoming flows of air 18, of natural gas 19 and an exhaust gas from a PSA unit form part of the item of information for predicting the variation the variation of a flow rate of flue gas leaving the upstream unit 2.

Hydrogen is recovered at the outlet 20 of the upstream unit 2.

The downstream unit comprises the compressor 5 and the rotational speed of this compressor 5 can be controlled by the control unit 4 in order to be increased, respectively decreased, in order to regulate the flow rate of flue gas in the direction of an increase, respectively of a decrease.

The fact of measuring the flow rates of gas, for example of air 18 and of methane 19 entering the upstream unit 2, makes it possible to anticipate the variations of flow rate of flue gas at the outlet of the upstream unit and/or pressure variations in this upstream unit. This anticipation makes it possible to better regulate these parameters and avoid failure modes that may lead to the shutdown of the upstream unit and/or of the downstream unit 3.

In the example from FIG. 1, the flow of flue gas between the upstream unit 2 and the downstream treatment unit 3 is, in nominal operation, isolated from the atmosphere, namely isolated from a stack 22 into which flue gas originating from the upstream unit 2 may be sent if need be.

A valve device 23 is positioned on an outlet line 24 which communicates between a stack and a line 25 for flow of flue gas between the upstream unit 2 and the downstream unit 4, this valve device 23 being arranged to be closed to isolate the stack 22 from the line 25 for flow of flue gas between the upstream unit 2 and the downstream unit 3.

In one variant that is not illustrated, the valve device 23 is positioned in the stack 22.

The valve device 23 comprises a damper butterfly valve.

This valve device 23 may also not be present, and the flow rate regulation of the flue gas entering the downstream unit is carried out by a compressor or a blower.

The process comprises the following step:
regulating, with the aid of the control unit 4, the flow rate of flue gas to the downstream treatment unit 3 with a view to maintaining the operating pressure at the outlet of the upstream unit 2 at the nominal operating pressure.

The nominal operating pressure corresponds to the atmospheric pressure.

The process further comprises the following steps:
measuring the pressure using a pressure sensor 29, in the flow of gas between the upstream unit 2 and the downstream unit 3, in particular the pressure at the outlet of the upstream unit, this pressure measurement being a predictive information item,
regulating the flue gas flow rate as a function of this pressure measurement, with a view to maintaining the operating pressure at the outlet of the upstream unit 2 at its nominal value.

The rotational speed of the compressor 5 of the downstream unit 3 can be controlled by the control unit 4, in order to be increased, respectively decreased, in order to regulate the flow rate of flue gas entering the downstream unit in the direction of an increase, respectively of a decrease, in order to lower, respectively increase, the operating pressure in the upstream unit 2.

In the case where the flow of flue gas between the upstream unit 2 and the downstream treatment unit 3 is, in nominal operation, isolated from the atmosphere, the pressure in the upstream unit cannot be equalized with the atmospheric pressure. In this case, it is possible to ensure that the nominal operating pressure of the upstream unit is maintained, to within a tolerance interval, for example of a few millibars, around atmospheric pressure.

A valve device 30 can be positioned between the inlet of the downstream unit 3 to help to regulate the flow rate of flue gas to the downstream unit 4. This valve device 30 here comprises a damper butterfly valve. Other types of valves may be provided.

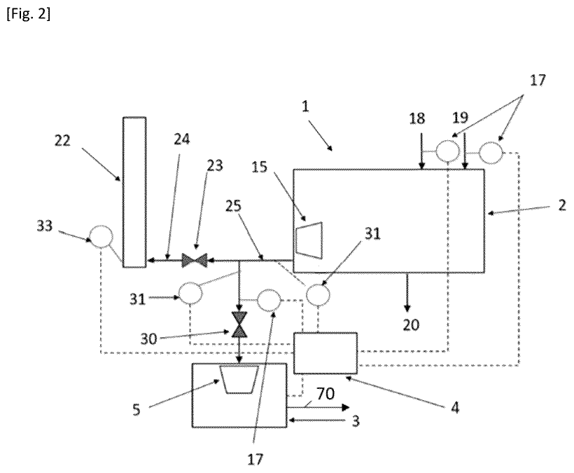

In the example from FIG. 2, most of the elements are identical to those of the embodiment from FIG. 1, except that the flow of flue gas between the upstream unit 2 and the downstream treatment unit 3 is, in nominal operation, in pressure equilibrium with the atmosphere.

The flow of flue gas communicates, via an outlet line 24, with the stack 22 opening to the atmosphere, and this outlet line 24 is left open, completely or partially, in nominal operation so as to make it possible to equilibrate the pressure in the flow of flue gas to atmospheric pressure.

The valve device 23 is positioned on the outlet line 24 which communicates between the stack 22 and a line 25 for flow of flue gas between the upstream unit and the downstream unit, this valve device 23 being arranged to be completely open or partially open.

The invention makes it possible, in this case, to ensure that the pressure in the upstream unit 2 is maintained at the nominal operating pressure, here atmospheric pressure. Thus, the risk of failure mode of the upstream unit is avoided owing to the stability of the pressure.

The process comprises the following step:
regulating the flow rate of flue gas between the upstream unit 2 and the downstream unit 3 so as to prevent an intake of air into the flow of flue gas or a portion of the flue gas from being introduced into the stack 22 then escaping into the atmosphere.

Outside air is prevented from adding to the flow of flue gas to be treated and from leading to a need for additional treatment capacity in the downstream unit owing to this undesirable excess air flow. Furthermore, flue gas that contains CO₂ is prevented from escaping into the atmosphere via the stack.

In the example from FIG. 2, the process comprises the following steps:
measuring a difference in oxygen concentration between the inlet of the downstream unit 3 and the outlet of the upstream unit 2 using sensors 31 for measuring O₂ concentration,
measuring a temperature of the air in the stack 22 or originating from the stack, using a temperature sensor 33,
determining, from these measurements, if air originating from the atmosphere is adding to the flow of flue gas, or if flue gas is escaping into the atmosphere through the stack 22,
regulating the flow rate of flue gas to prevent this addition of air to the flow of flue gas or to prevent flue gas from escaping into the atmosphere.

Prior to the control corrections as a function of the temperature and oxygen concentration as described above, regulation is carried out with the flow that arrives at the downstream unit, the setpoint value of which for the regulation can be corrected by means of measurements of the flow rates entering the upstream unit.

In the case where the difference in oxygen concentration increases between the inlet of the downstream treatment unit 3 and the outlet of the upstream 2, the control unit 4 orders a reduction of the rotational speed of the compressor of the downstream unit.

In the case where the temperature of the gases in the stack increases, the control unit 4 orders an increase of the rotational speed of the compressor 5 of the downstream unit 4.

A measurement of the flow flowing to the downstream unit 3 is carried out by a sensor 17 on the flow line 25.

In the present example, the process comprises the following steps:
measuring at least one flow rate of gas entering the upstream unit 2, in particular the flow rate of the various gases entering the upstream unit 2 which represent at least 80% of all of the gases entering the upstream unit, these measured flow rates forming part of an item of information for predicting the variation of a flow rate of flue gas leaving the upstream unit,
regulating the flow rate of flue gas between the upstream unit 2 and the downstream unit 4 as a function of the predictive information item which is this or these measured flow rate(s), in particular by increasing the flow rate of flue gas leaving the upstream unit by sucking up more flue gas, in particular by increasing the flow area of a valve device 30 and/or by increasing the rotational speed of the compressor or of the blower and/or by modifying the position of a variable vane of the compressor or of the blower.

In order to reduce the amount of air entering the downstream unit 4, the regulation consists in particular in decreasing the flow area of the valve device 30 and/or in reducing the rotational speed of the compressor or of the blower and/or in modifying the position of the variable vane of the compressor or of the blower. In order to reduce the amount of flue gas that escapes into the atmosphere, the regulation consists in particular in increasing the flow area of the valve device 30 and/or in increasing the rotational speed of the compressor or of the blower and/or in modifying the position of the variable vane.

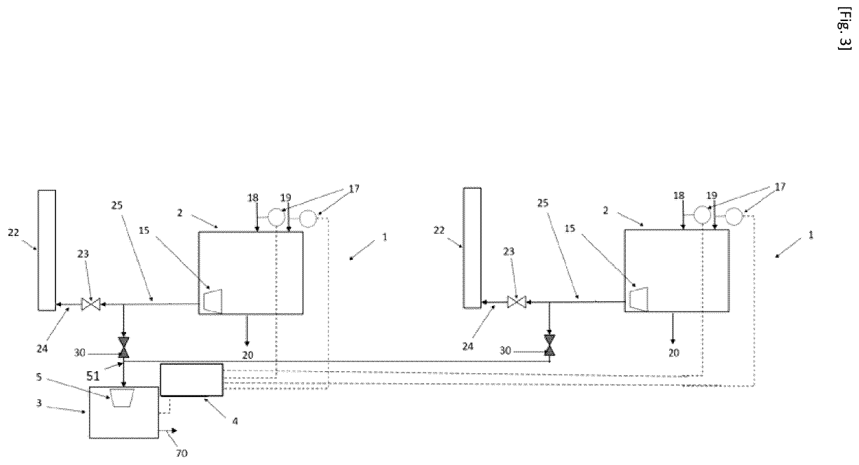

Represented in FIG. 3 is another embodiment of the invention in which two upstream units 2 and one downstream unit 3 are provided.

Two valves 30 are associated with the two upstream units 2, with a mixing point 51 of the streams coming from the two valves 30. The mixture of the streams then goes towards the downstream unit 3.

One of the valves 30 is left wide open and the other is left partially open, or one is left more open than the other, in order to compensate for the difference in pressure drops between one of the upstream units 2 and the mixing point 51 and the other upstream unit and the mixing point 51.

While the invention has been described in conjunction with specific embodiments thereof, it is evident that many alternatives, modifications, and variations will be apparent to those skilled in the art in light of the foregoing description. Accordingly, it is intended to embrace all such alternatives, modifications, and variations as fall within the spirit and broad scope of the appended claims. The present invention may suitably comprise, consist or consist essentially of the elements disclosed and may be practiced in the absence of an element not disclosed. Furthermore, if there is language referring to order, such as first and second, it should be understood in an exemplary sense and not in a limiting sense. For example, it can be recognized by those skilled in the art that certain steps can be combined into a single step.

The singular forms “a”, “an” and “the” include plural referents, unless the context clearly dictates otherwise.

“Comprising” in a claim is an open transitional term which means the subsequently identified claim elements are a nonexclusive listing i.e. anything else may be additionally included and remain within the scope of “comprising.” “Comprising” is defined herein as necessarily encompassing the more limited transitional terms “consisting essentially of” and “consisting of”; “comprising” may therefore be replaced by “consisting essentially of” or “consisting of” and remain within the expressly defined scope of “comprising”.

“Providing” in a claim is defined to mean furnishing, supplying, making available, or preparing something. The step may be performed by any actor in the absence of express language in the claim to the contrary.

Optional or optionally means that the subsequently described event or circumstances may or may not occur. The description includes instances where the event or circumstance occurs and instances where it does not occur.

Ranges may be expressed herein as from about one particular value, and/or to about another particular value. When such a range is expressed, it is to be understood that another embodiment is from the one particular value and/or to the other particular value, along with all combinations within said range.

All references identified herein are each hereby incorporated by reference into this application in their entireties, as well as for the specific information for which each is cited.

1-12. (canceled)

13. A process for treating a flue gas produced in at least one upstream unit operating at a nominal operating pressure, the flue gas containing from 5 mol % to 90 mol % of carbon dioxide on a wet basis and being at a pressure between 0.5 and 2 bar absolute, the process comprising:
treating, via at least one downstream treatment unit, all or virtually all of the stream of flue gas originating from the upstream unit or upstream units, thereby producing, from said flue gas, a gaseous or liquid stream rich in carbon dioxide which contains more than 50 mol % of carbon dioxide,
enabling the stream of flue gas to communicate, between the upstream unit and the downstream unit, via an outlet line, with a stack opening to the atmosphere, and this outlet line is left open or partially open in nominal operation thereby equilibrating the pressure in the stream of flue gas to atmospheric pressure.

14. The process of claim 13, comprising:
detecting at least one item of information for predicting the variation of a flow rate of flue gas leaving the upstream unit, the predictive information item being different from a measurement of pressure, flow rate or overall composition of the flue gases,
regulating the flow rate of flue gas between the upstream unit and the downstream treatment unit as a function of the predictive information item using a valve device for the passage of the flue gas and/or a pressure increase device positioned between the upstream unit and the downstream unit or within the downstream unit.

15. The process of claim 13, wherein a valve device is positioned:
on the outlet line which communicates between the stack and a line for flow of flue gas between the upstream unit and the downstream unit, or
on a line for flow of flue gas between the upstream unit and the downstream unit, or
in the stack,
the valve device being configured to be open or partially open and the valve device comprises a valve which is for example a butterfly valve such as a damper butterfly valve.

16. The process of claim 15, wherein the valve device is arranged to have an opening between 5% and 100% of the maximum opening permitted by the valve device.

17. The process of claim 13, wherein a pressure increase device, configured to increase the pressure of the gaseous stream of flue gas, is provided, the pressure increase device comprising a compressor or a blower.

18. The process of claim 13, comprising:
measuring at least one flow rate of gas entering the upstream unit, wherein the at least one flow rate of gas comprises the flow rate of the various gases entering the upstream unit which represent at least 80% of all of the gases entering the upstream unit, the measured flow rates forming part of an item of information for predicting the variation of a flow rate of flue gas leaving the upstream unit,
regulating the flow rate of flue gas between the upstream unit and the downstream unit as a function of the predictive information item which is the measured flow rate(s) by increasing the flow rate of flue gas leaving the upstream unit by sucking up more flue gas, by increasing the flow area of a valve device and/or by increasing the rotational speed of the compressor or of the blower and/or by modifying the position of a variable vane of the compressor or of the blower.

19. The process of claim 13, comprising:
measuring one or more oxygen concentrations in the flow of flue gas, or a difference in oxygen concentration between the inlet of the downstream unit and the outlet of the upstream unit, and/or
measuring one or more temperatures of the air in the stack or originating from the stack,
determining, from the measurements, if air originating from the atmosphere is adding to the flow of flue gas, or if flue gas is escaping into the atmosphere through the stack,
regulating the flow rate of flue gas to prevent the addition of air to the flow of flue gas or to prevent flue gas from escaping into the atmosphere.

20. The process of claim 13, wherein a failure mode or a disturbance or an alarm of the upstream device is taken into account in order to regulate the flow rate of flue gas arriving in the downstream treatment unit, an item of information for predicting the variation of a flow rate of flue gas leaving the upstream unit then being the detection of this failure mode or this disturbance or this alarm.

21. The process of claim 13, wherein the upstream treatment unit comprises a pressure swing adsorption (PSA) device, and a failure mode or a disturbance or an alarm of this PSA device is taken into account in order to regulate the flow rate of flue gas arriving in the downstream treatment unit, an item of information for predicting the variation of a flow rate of flue gas leaving the upstream unit then being the detection of this failure mode or this disturbance or this alarm.

22. The process of claim 13, wherein the upstream unit or at least one of the upstream units is a steam methane reforming unit.

23. The process of claim 13, wherein the downstream unit comprises one or more units for purifying carbon dioxide cryogenically, or one or more amine scrubbing units.

24. The process of claim 13, wherein the upstream units and downstream units are connected to a same flue gas network.
